(19) United States
(12) Patent Application Publication
(10) Pub. No.: US 2025/0319597 A1
(43) Pub. Date: Oct. 16, 2025

(54) METHOD, SAFETY DEVICE AND MACHINE ASSEMBLY FOR THE SAFE OPERATION OF A MOVABLE MACHINE

(71) Applicant: SICK AG, Waldkirch (DE)

(72) Inventors: Peter POKRANDT, Au am Rhein (DE); Markus HAMMES, Freiburg (DE)

(21) Appl. No.: 19/174,854

(22) Filed: Apr. 9, 2025

(30) Foreign Application Priority Data
Apr. 16, 2024 (EP) 24170410.5

(51) Int. Cl. B25J 9/16

(52) U.S. Cl. CPC B25J 9/1676

(57) ABSTRACT

A method for the safe operation of a movable machine comprises: that the movable machine is controlled by a control unit; that a sensor apparatus determines a 3D representation of an environment of the movable machine; that an initial protective field is predefined that is a defined spatial region within the environment of the movable machine; that a first adaptation apparatus and a second adaptation apparatus receive state data about the movable machine from the control unit, wherein the first adaptation apparatus, starting from the initial protective field, determines a first adapted protective field in dependence on the state data and the second adaptation apparatus, starting from the initial protective field, determines a second adapted protective field in dependence on the state data; that a relevant protective field is determined on the basis of both the first adapted protective field and the second adapted protective field; that an evaluation apparatus evaluates the determined 3D representation with respect to whether an object engages into the relevant protective field, and outputs a result signal in dependence on the result of the evaluation; and that the control unit triggers a safety-related reaction if the result signal corresponds to an engagement of an object into the relevant protective field.

The invention relates to a method for the safe operation of a movable machine, to a safety device for the safe operation of a movable machine, and to a machine assembly for the safe operation of a movable machine, in each case in particular as part of a human-robot interaction.

Robots or comparable movable machines are above all used in industrial environments to perform certain tasks. This in particular relates to tasks during which particularly large forces have to be exerted and/or which have to be performed at a high speed and with a high precision, in particular if the respective task very often has to be performed in the same way. However, there are also tasks that can be performed better by a human than by a machine. This in particular relates to tasks that are difficult to automate, for instance because they require experience and/or a high degree of adaptability. In processes that involve both work of the one kind and work of the other kind, it can therefore be expedient if humans and machines work together to combine their respective strengths as efficiently as possible.

The nature of the cooperation can be different in this respect. For example, the working zones of a robot and a human can merely overlap, wherein no direct interaction between the robot and the human takes place, or wherein an interaction is only provided when the robot is stationary. Such a form of cooperation is also called human-robot cooperation. However, the cooperation can also go so far that a direct interaction up to a scheduled contact between a human and a robot takes place, for instance when the human and the robot simultaneously work on one workpiece or the robot is hand-guided. This kind of cooperation is also called human-robot collaboration. With respect to the present invention, human-robot interaction is to be understood in a rather broad sense and can comprise all the mentioned forms of the cooperation, in particular both human-robot collaboration and human-robot co-operation.

Due to a human-robot interaction, high requirements result with respect to the safety of the persons involved since the respective movable machine can in particular pose a danger to persons in its direct environment due to its power and speed. However, a hazard for persons working with the movable machine can also arise at low forces or speeds, for example due to parts or structures of the movable machine that are dangerous per se, for instance, because they are pointed, sharp-edged or hot. If the movable machine is configured as a robot arm, a hazard can in particular arise from a tool that is provided at the robot arm or in a tool mount of the robot arm, typically at its free end.

Precautions must therefore be taken to rule out an endangering of persons as far as possible. Such precautions include both passive measures, such as avoiding hard or sharp edges at outer sides of the movable machine and rather providing soft and/or rounded surfaces, and active safety mechanisms that trigger a specific safety-related reaction in the event of a danger to a person in order to avert this danger.

If, as part of a human-robot interaction, robots or comparable movable machines, such as AGVs (Automated Guided Vehicles), AGCs (Automated Guided Containers) or drones, work together with persons in a defined working environment without being spatially separated from one another by a concrete separation apparatus (such as a wall), a danger to a person involved can in particular result if a collision occurs between the machine and the person. This danger can be countered in various ways.

One possibility is that the movable machine is only operated under the direct control of a human who can thus himself ensure that neither he nor other persons are endangered by the machine. However, if the control of the movable machine takes place automatically or if the movable machine even works autonomously, the safety of the persons working together with the machine can be ensured in accordance with a further safety concept by generally limiting the movements of the machine, in particular its force and speed, such that an injury to persons involved in the event of a collision can be largely ruled out in advance. Furthermore, according to an alternative safety concept, it can be provided that the movable machine can only be put into operation at all if there is no human in a defined environment of the movable machine, and that the machine is immediately stopped as soon as a human enters the defined environment.

However, such safety concepts can be too restrictive for dynamic applications in which high process speeds are sought after. For this reason, a safety concept called speed-and-separation monitoring is often used, in which the speed of the movable machine is reduced as the distance between the movable machine and persons in its environment decreases. In this way, when a person approaches the movable machine, initially, only an evasive movement or a slowing down of the machine movement can take place; a complete stop of the movable machine, on the other hand, is only intended for very short distances.

The speed-and-separation monitoring requires a very dynamic control of the movable machine and a precise monitoring of the environment of the movable machine. The monitoring can in particular take place based on protective fields. This means that one or more protective fields are defined, each of which is a defined spatial region within the environment of the movable machine that is monitored by means of a sensor apparatus. The data acquired by the sensor apparatus can then be evaluated with respect to whether any object (e.g. a person working together with the movable machine) engages into the respective protective field so that a suitable safety-related reaction can be triggered if necessary. In this respect, the protective fields can each extend around the movable machine. Different protective fields can surround the movable machine at different distances from the movable machine so that different safety-related reactions (evasion, braking, stopping) can be triggered in stages depending on the protective field that is engaged into. An engagement into the protective field closest to the movable machine expediently leads to an emergency stop of the machine.

For industrial applications with significant hazard potential, these functions must be implemented according to the rules of functional safety with a high safety level. The basic standard IEC 61508:2010 and the C standard for robot safeguarding measures EN ISO 10218:2011, the standards DIN EN ISO 13849-1:2023-12 and DIN EN ISO 13849-2:2013-02 for machine safety and the device standards DIN EN IEC 61496-1:2021-06, DIN EN IEC 61496-2:2021-08 and DIN EN IEC 61496-3:2019-10 for electrosensitive protective equipment (ESPE) are in particular relevant in this respect. The designation of a function, an apparatus or a method step as safe is here to be understood within the meaning of these standards. To meet these standards, a series of measures are to be taken that in particular comprise a safe electronic evaluation by redundant and diverse electronics and different function monitoring processes, among them the monitoring of the contamination of optical components, including their respective front lenses.

The protective field function described can largely be fully realized within a certified sensor apparatus. In this respect, a protective field to be monitored can be predefined and also validated for a respective sensor apparatus—for example by a teaching-in process or as three-dimensional spatial data, for instance spatial data defined by means of CAD. The monitoring of the protective field then takes place in the sensor apparatus, as does the safety-related decision, which is made based on the acquired data, about the triggering of a safety-related reaction. The signal output by the sensor apparatus can then substantially comprise the mere result of the safety-related decision and can be binary in this regard: If the signal is negative, no reaction takes place; if the signal is positive, an emergency stop of the movable machine takes place. In this simple form, the safety function is easily configurable and allows a safeguarding at the component level.

However, such a protective field-based safeguarding is inflexible. This is because the configuration (in particular the defining of the respective protective field) takes place at the point in time of the configuration of the application based on planned or expected movement sequences and worst-case considerations. However, no dynamic information about the respective current working and movement state of the movable machine is considered. It is therefore also not possible to react dynamically to new situations in which, for example, temporary engagements into certain regions of the predefined protective field would not be dangerous and the triggering of the emergency stop would thus be unnecessary. This is at the expense of the productive sequences.

However, a dynamic adaptation of the respective protective field to different states of the movable machine would in turn have to meet the requirements for a standard-compliant safe operation and can therefore not be easily realized within the sensor apparatus.

It is an object of the invention to enable a safe protective field-based operation of a movable machine in which the respective protective field can be dynamically adapted in real time to the respective current state of the movable machine and which simultaneously has a high safety level.

The object is satisfied by a method having the features of claim 1; by a safety device having the features of claim 11; and by a machine assembly having the features of claim 15. Advantageous embodiments result from the dependent claims, the present description, and the Figures.

The method according to the invention for the safe operation of a movable machine comprises: that the movable machine is controlled by a control unit; that a sensor apparatus determines a 3D representation of an environment of the movable machine; that an initial protective field is predefined that is a defined spatial region within the environment of the movable machine; that a first adaptation apparatus and a second adaptation apparatus receive state data about the movable machine from the control unit, wherein the first adaptation apparatus, starting from the initial protective field, determines a first adapted protective field in dependence on the state data and the second adaptation apparatus, starting from the initial protective field, determines a second adapted protective field in dependence on the state data; that a relevant protective field is determined on the basis of both the first adapted protective field and the second adapted protective field; that an evaluation apparatus evaluates the determined 3D representation with respect to whether an object engages into the relevant protective field, and outputs a result signal in dependence on the result of the evaluation; and that the control unit triggers a safety-related reaction if the result signal corresponds to an engagement of an object into the relevant protective field.

The method helps to operate the movable machine in a way that is safe within the meaning of the standards mentioned. The movable machine is in this respect controlled by means of said control unit, in particular to carry out certain movements and/or work. In this respect, the movable machine assumes various states that can, for example, differ in terms of the respective position, the respective movement and/or the respective operating mode (for example: tool active/inactive) of the movable machine.

By means of the sensor apparatus, an environment of the movable machine can in this respect be monitored, preferably continuously, during the operation of the movable machine by detecting the spatial structure of the environment (including objects possibly located in the environment). Said determination of the 3D representation of the environment can therefore mean that position data (spatial information) about the environment are acquired by means of the sensor apparatus and a 3D representation of the environment is determined based on the acquired position data. The position data or the 3D representation in this respect inevitably also comprises spatial information about objects that are located within the environment of the movable machine. It is generally conceivable in this respect to differentiate the objects from one another, for instance by identifying mutually separate spatial structures within the acquired position data about the environment or within the determined 3D representation of the environment by segmentation or clustering. However, such a distinction between separate objects is advantageously not necessary at all for the method according to the invention.

Based on the acquired spatial information, changes, i.e. movements, can generally also be detected and can be incorporated into the position data or the 3D representation. However, to detect engagements into respective protective fields, it may be sufficient if only the currently present state of the environment of the movable machine is considered in each case.

The sensor apparatus can comprise one or more sensors. A plurality of sensors can be expedient to monitor the environment of the movable machine from different directions. Hidden regions can be avoided in this way. Furthermore, it can be expedient to use a plurality of sensors, which are based on different measurement techniques, for a redundant and diverse determination of the 3D representation.

The 3D representation can in particular be determined in the form of a two-dimensional depth map. This is a two-dimensional image of an acquired three-dimensional spatial region from the perspective of the respective sensor of the sensor apparatus, wherein each pixel of the image, unlike in a conventional image, does not visually represent the point of the environment that is visible at the corresponding viewing angle, but rather indicates the distance of this point from the sensor. Various types of sensors, in particular optical sensors, are known by which such depth maps can be produced. Such sensors can, for example, be based on stereoscopy, triangulation, a measurement of the time of flight, interference of passive two-dimensional patterns, or the evaluation of projected illumination patterns. The sensor apparatus can in particular comprise at least one safety scanner as described in EP 2 395 372 A1 and/or an optoelectronic sensor as described in EP 2 048 557 A1.

Within said environment of the movable machine, one or more spatial regions can then be defined as respective protective fields by which it is supposed to be ensured that an approach of an object (a person) to the movable machine can be detected and responded to in a safety-oriented manner. For this purpose, the protective fields are expediently arranged between the movable machine and the area occupied by persons; in particular, the protective fields can at least substantially surround the movable machine—as a kind of protective jacket. If a plurality of protective fields are provided, they can be arranged at different distances from the movable machine so that, depending on which protective field is engaged into, a corresponding safety-related reaction can be triggered (which becomes more extensive as the distance decreases). In the following, only a single one of possibly a plurality of protective fields is considered in each case. The method described can be limited to the one protective field; however, it is also conceivable that the method is used in parallel for a plurality of protective fields.

A respective protective field is preferably formed by a continuous spatial region. However, a protective field can generally also comprise two or more mutually separate and spaced-apart spatial regions.

The defined protective field in this respect represents an initial protective field in that it is defined as part of a configuration, which is expediently performed before the operation of the movable machine, and is then predefined for the further method. For example, a configuration device as described in EP 2 048 557 A1 can be used for this purpose. Alternatively or in addition thereto, the initial protective field can also be defined in a CAD-like program comprising a graphical user interface relative to a model or image of the environment of the movable machine. The configuration of the initial protective field is comparatively complex—precisely because it is safety-relevant—especially since the protective field usually still has to be validated once it has been defined. The configuration is therefore normally only performed again if the movable machine is configured for a new application. The initial protective field is static in this regard.

The initial protective field is expediently defined in terms of a worst-case scenario so that it forms a kind of virtual protective wall of sufficient thickness around the movable machine in every working state, position state and movement state of the movable machine. The initial protective field is in particular arranged such that the movable machine does not engage into the protective field in any position which it can assume and has such a large thickness that even in the potentially most dangerous operating state of the movable machine (such as at a high movement speed or with an active tool), an approach to the movable machine can be detected in good time so that a hazard can be avoided by triggering a suitable safety-related reaction.

However, depending on the current state of the movable machine, sufficient safety could in many cases also be achieved at least temporarily by a protective field that at least regionally has a smaller thickness or is arranged closer to the movable machine than the initial protective field generally defined for all possible states. For example, the protective field could substantially nestle against the movable machine when the movable machine is stationary and/or can have a smaller thickness when the tool is inactive than when it is active.

For this reason, according to the invention, the initial protective field is not used directly as the relevant protective field for monitoring the environment of the movable machine with respect to a potentially dangerous approach of an object (a person) to the movable machine, but the relevant protective field is rather determined on the basis of both a first adapted protective field and a second adapted protective field. For these adapted protective fields, the initial protective field is indeed assumed in each case, but, unlike the initial protective field, the adapted protective fields are determined in dependence on state data about the movable machine, i.e. data that describe the state currently predefined or assumed in accordance with the control by the control unit (desired state or actual state). In this respect, the state can in particular refer to the current position, the current movement and/or the current operating mode of the movable machine.

By considering these state data, the first adapted protective field and the second adapted protective field are dynamic protective fields by which a greater flexibility can be achieved during a cooperation of persons with the movable machine than by the static initial protective field. However, the determination of these dynamic protective fields takes place outside the sensor apparatus that is configured in a safe manner (preferably certified as safe) and must be performed without a manual validation by a user due to the ongoing operation of the movable machine. In particular, it is preferred that the determination of the adapted protective fields takes place automatically completely without the involvement by a user. It must therefore be ensured in another way that the adaptation of the protective field is performed safely. This is achieved through redundancy, on the one hand, and diversity, on the other hand, according to the standards mentioned.

The redundancy results from the fact that not only one adapted protective field is determined, but rather a first adapted protective field and a second adapted protective field are determined. The diversity is achieved in that a first adaptation apparatus and a second adaptation apparatus, which are preferably independent of one another, are used for determining the adapted protective fields. This can comprise the first adaptation apparatus and the second adaptation apparatus being formed separately from one another.

For example, the two adaptation apparatuses can, for instance, each have their own processing unit that, for example, comprises an integrated circuit (IC), a microprocessor, a central processing unit (CPU), a graphics processing unit (GPU), an application-specific integrated circuit (ASIC) and/or a field programmable gate array (FPGA), or is at least substantially formed thereby. The two adaptation apparatuses can then differ from one another with respect to the type of the processing unit. According to an advantageous embodiment, it is alternatively or additionally provided that the first adapted protective field is determined by the first adaptation apparatus in accordance with a first algorithm and the second adapted protective field is determined by the second adaptation apparatus in accordance with a second algorithm, in particular an independent algorithm, that is different from the first algorithm, wherein the different algorithms are expediently adapted such that they lead to the same result for the same input values.

Due to the diverse determination of the two adapted protective fields, they so-to-say validate one another since it is unlikely that two adapted protective fields determined in different ways will match if there is an error when determining one of the two protective fields (or both).

The adapted protective fields can each be determined, for example, by modifying the initial protective field in dependence on the state data. In this respect, it is conceivable that, depending on the received state data, it occurs that the adapted protective fields are identical to the initial protective field. For example, the adapted protective fields can correspond directly to the initial protective field as long as the movable machine exceeds a certain speed, travels a certain trajectory and/or is operated in a certain operating mode. Preferably, however, the adapted protective fields differ from the initial protective field in at least some states of the movable machine.

Various algorithms or other methods can generally be considered for the determination of the adapted protective fields and can be known per se. For the present invention, it is in this respect not important in which specific way the first adapted protective field and the second adapted protective field are determined. However, it is essential that the state data are included in the determination of the adapted protective fields. The two adaptation apparatuses each receive these state data from the control unit. Both adaptation apparatuses each receive the same state data from the control unit. In this respect, they can receive the state data directly or indirectly from the control unit and can for this purpose be directly or indirectly connected to the control unit, preferably in a wired manner, but generally also wirelessly.

If a variable is determined redundantly and diversely as part of a safe method so that, as a result, two variables determined in different ways are present that are expected to match, it is common practice to subsequently compare the variables with one another and to continue using one of the two variables if there is a (sufficient) match, but to discard both variables as inconsistent if there is a (significant) deviation. For the present method, this would mean that the two adapted protective fields would have to be compared and, if an inconsistency is detected, not only would both have to be discarded for safety reasons, but a safety-related shutdown (emergency stop) of the movable machine would also have to be triggered. However, checking the two protective fields for sufficient consistency can be relatively computationally complex. Furthermore, it may be that the inconsistency detected in the current situation is irrelevant for safety since the situation is de facto harmless so that the safety-related shutdown would be unnecessary.

For this reason, in the method according to the invention, a comparison of the first adapted protective field with the second adapted protective field preferably does not take place and the relevant protective field is not simply equated with one of the two adapted protective fields either, but the relevant protective field is rather determined on the basis of both the first adapted protective field and the second adapted protective field. This means that both the first adapted protective field and the second adapted protective field are specifically included in the relevant protective field. For example, the determination of the relevant protective field can comprise that parts of the relevant protective field are directly taken from the first adapted protective field, while other (the remaining) parts of the relevant protective field are directly taken over from the second adapted protective field so that the relevant protective field corresponds in part to the first adapted protective field and in part to the second adapted protective field.

Due to such a combined consideration of both adapted protective fields in the relevant protective field, the relevant protective field as a whole can provide a reliable foundation for a fail-safe operation of the movable machine. At the same time, a time-consuming cross-comparison between the adapted protective fields can be avoided, on the one hand, and, on the other hand, it can be avoided that the movable machine is shut down for safety reasons, even though this would not be absolutely necessary despite a possible inconsistency of the adapted protective fields.

The determination of the relevant protective field preferably takes place automatically, in particular without manual inputs or having to be triggered by a user. The relevant protective field can be continuously redetermined during the operation of the movable machine. In particular, a new relevant protective field can be determined whenever the first adaptation apparatus and the second adaptation apparatus determine a new first adapted protective field or a new second adapted protective field based on the respective current state data received from the sensor apparatus. In particular, it can be provided that new adapted protective fields are each (only) determined if the state data have changed significantly (for example, due to a change in the position or movement of the movable machine beyond a predefined level or due to a change in the operating mode of the movable machine).

For the determination of the relevant protective field, a separate protective field determination apparatus can be provided that receives the adapted protective fields from the adaptation apparatuses, and outputs the relevant protective field to the evaluation apparatus. However, the relevant protective field is preferably determined by the evaluation apparatus that receives the first adapted protective field and the second adapted protective field from the adaptation apparatuses for this purpose.

The evaluation apparatus is preferably integrated into the sensor apparatus. However, the evaluation apparatus can generally also be configured as a separate apparatus from the sensor apparatus (and the adaptation apparatuses).

The evaluation apparatus can receive the 3D representation determined by the sensor apparatus directly or indirectly from the sensor apparatus and can for this purpose be directly or indirectly connected to the sensor apparatus, preferably in a wired manner, but generally also wirelessly. The determined 3D representation is then evaluated by the evaluation apparatus with respect to whether an (arbitrary) object engages into the relevant protective field. This is the case if any spatial structure covered by the 3D representation is located at least partly within the protective field.

Finally, the evaluation apparatus outputs a result signal in dependence on the result of said evaluation. The result signal can in particular correspond directly to the result of the evaluation. Depending on this, the result signal therefore either corresponds to an engagement of an object into the protective field or to no engagement of an object into the protective field. In this regard, the result signal is a binary signal. In this respect, it may be sufficient if a specific signal is only output in the case of one of the two results (positive result signal), while no signal is output for signaling the other case (negative result signal). In particular, it can be provided that a specific signal is output as the result signal as long as the evaluation leads to the result that there is no engagement into the relevant protective field, whereas an engagement into the protective field is signaled by the absence of this specific signal. In this way, a failure of the evaluation apparatus or an interference in the signal transmission advantageously leads to a safety-related reaction in the same way as an engagement into the protective field.

The result signal output by the evaluation apparatus is (directly or indirectly) received by the control unit that then triggers a safety-related reaction if the result signal corresponds to an engagement of an object into the relevant protective field. The safety-related reaction can in particular, for example, consist of the control unit controlling the movable machine to move at a reduced speed or to stop. If the relevant protective field is based on the innermost of possibly a plurality of initial protective fields, the safety-related reaction preferably consists of a safety-related shutdown of the movable machine.

Said method steps preferably each take place real time and in particular do not require a manual validation by a user. If the method is performed continuously, a previously determined relevant protective field (in particular the one determined in the previous iteration) can in each case be assumed as the initial protective field in subsequent iterations of the method. However, the same initial protective field is preferably assumed throughout.

According to an advantageous embodiment, the determination of the relevant protective field comprises that the first adapted protective field and the second adapted protective field are spatially superposed. The superposition can, for example, consist of the relevant protective field being formed by an addition in the sense of a spatial union of the two adapted protective fields. Alternatively thereto, it can be provided that the relevant protective field partly corresponds to the first adapted protective field and partly corresponds to the second adapted protective field, wherein the distribution is advantageously selected such that a homogeneous mixture of the two adapted protective fields is achieved. The two adapted protective fields can in particular be spatially interwoven by the superposition.

As a result of the superposition, the relevant protective field corresponds to a spatial combination of the first adapted protective field and the second adapted protective field with one another, which combination makes it possible that both adapted protective fields are always considered. A comparison of the two adapted protective fields can thereby be omitted and no decision between the two adapted protective fields must be made either. If one of the adapted protective fields is faulty, it is unlikely that the other will also be faulty at the same time. The spatial superposition in this respect ensures that the non-faulty adapted protective field is in any case also considered so that there is no need for a safety-related shutdown even in the event of a possible discrepancy between the adapted protective fields. According to a further advantageous embodiment, the relevant protective field is determined in the form of a relevant lookup table, wherein said evaluation (of the determined 3D representation with respect to whether an object engages into the relevant protective field) comprises that the determined 3D representation is compared with the relevant lookup table. The designation of the decisive lookup table as “relevant” in this respect only serves to differentiate it conceptually from the first lookup table and the second lookup table that are also described further below. In other words: The relevant protective field is determined in the form of a lookup table that is designated as the relevant lookup table in the following.

The relevant lookup table can in particular be a two-dimensional table whose values correspond to a third dimension. In this respect, the relevant lookup table preferably corresponds to a two-dimensional depth map, wherein the determined 3D representation is also available as a two-dimensional depth map, and wherein the relevant lookup table and the determined 3D representation correspond to one another in terms of their dimensions (width and height or resolution). (The same preferably applies accordingly to the first and the second lookup table that are described further below.)

The determination of the relevant protective field in the form of a relevant lookup table can comprise that the relevant protective field is first defined as a three-dimensional spatial region and the latter is then converted into the relevant lookup table by converting it into a two-dimensional depth map of the relevant protective field from the perspective of the sensor apparatus, preferably while considering optical parameters of the sensor apparatus. However, the relevant protective field can also be directly determined as a relevant lookup table, for example, in that the latter is formed by a combination of the first lookup table and the second lookup table, as explained further below.

If the relevant lookup table corresponds to a two-dimensional depth map, the determined 3D representation and the relevant lookup table can be easily compared by comparing each value (pixel) of the determined 3D representation with the value of the corresponding field (pixel) of the lookup table. The comparison can in this respect be limited to those values which can be assigned to the relevant protective field due to their position within the 3D representation or the lookup table. If such a value of the determined 3D representation corresponds to a smaller distance from the sensor apparatus than the corresponding value stored in the relevant lookup table, this is an indication that an object is located in the relevant protective field.

The lookup table can also be defined such that it is not necessary to differentiate between values that are to be assigned to the relevant protective field and those that are not to be assigned to the relevant protective field, but that all the values of the determined 3D representation are each compared with the corresponding value of the relevant lookup table. For example, when determining the relevant lookup table, all the values that are not to be assigned to the relevant protective field can for this purpose be set to a distance of zero so that only values of the determined 3D representation that are to be assigned to the relevant protective field can be smaller than the corresponding value stored in the relevant lookup table. If it is then determined for any desired value of the determined 3D representation that said value corresponds to a smaller distance from the sensor apparatus than the corresponding value stored in the relevant lookup table, this is an indication that an object is located in the relevant protective field.

In this respect, it can in each case be provided that as soon as a single such indication is present, the result of the evaluation corresponds to an engagement of an object into the relevant protective field. However, it is also conceivable that the evaluation only leads to this result if such an indication is available for a plurality of mutually adjacent values (pixels).

According to a further advantageous embodiment, the first adapted protective field is determined in the form of a first lookup table, the second adapted protective field is determined in the form of a second lookup table and the determination of the relevant protective field (in the form of the relevant lookup table) comprises: that a first partial lookup table is formed by subsampling the first lookup table in accordance with a predefined sampling pattern; that a second partial lookup table is formed by subsampling the second lookup table in accordance with the inverse of the predefined sampling pattern; and that the relevant lookup table is formed by combining the first partial lookup table with the second partial lookup table.

The determination of the first adapted protective field in the form of a first lookup table and the determination of the second adapted protective field in the form of a second lookup table can in each case comprise that the first or second protective field is first defined as a three-dimensional spatial region that is then converted into the first or second lookup table by converting it into a two-dimensional depth map of the first or second protective field from the perspective of the sensor apparatus, preferably while considering optical parameters of the sensor apparatus. In this respect, the first lookup table and the second lookup table are in particular each determined such that they have the same dimensions (width and height or resolution) as the 3D representation that is preferably determined as a depth map. Furthermore, the initial protective field can also already be defined in the form of an (initial) lookup table which is produced in a corresponding manner and starting from which the two adapted protective fields can then each be determined directly in the form of a lookup table.

For the determination of the relevant protective field (in the form of the relevant lookup table), a first partial lookup table and a second partial lookup table are first formed from the first lookup table and the second lookup table by subsampling. In this respect, the first partial lookup table is preferably formed by the first adaptation apparatus and the second partial lookup table is preferably formed by the second adaptation apparatus.

Said subsampling is a spatial subsampling in each case. The subsampling of the first lookup table takes place in accordance with a predefined sampling pattern that defines, for each field of the first lookup table, whether it is retained or discarded (e.g. emptied or set to zero). In contrast, the subsampling of the second lookup table takes place in accordance with the inverse of this predefined sampling pattern so that each field of the second lookup table that corresponds to a retained field of the first lookup table is discarded, and each field of the second lookup table that corresponds to a discarded field of the first lookup table is retained. The two partial lookup tables thus comprise mutually complementary parts of the respective lookup table from which they are formed. The first partial lookup table and the second partial lookup table are consequently spatially disjoint, but their spatial overlap corresponds to a complete lookup table again.

Therefore, the relevant lookup table can be formed by combining, namely in particular by spatially superposing, the first partial lookup table and the second partial lookup table. Each field of the relevant lookup table then, in accordance with the sampling pattern, contains either the value of the corresponding field of the first lookup table (namely if this field is retained in accordance with the sampling pattern) or the value of the corresponding field of the second lookup table (namely if this field is discarded in accordance with the sampling pattern and is thus retained in accordance with the inverse of the sampling pattern). If it is provided that fields are discarded during the subsampling by setting them to zero, the combination of the first partial lookup table and the second partial lookup table with one another can also take place by adding the two partial lookup tables.

The formation of the relevant lookup table by combining the two partial lookup tables with one another preferably takes place by the evaluation apparatus. For this purpose, the evaluation apparatus can receive the first partial lookup table from the first adaptation apparatus and the second partial lookup table from the second adaptation apparatus. In particular, it can be provided that the evaluation apparatus only receives the respective partial lookup table from the adaptation apparatuses and not also the respective (complete) lookup table.

According to an advantageous embodiment, due to the subsampling, in each case at least substantially half of the fields of the respective lookup table are discarded. In other words, the sampling pattern is formed such that, during the subsampling of the first lookup table, at least substantially half of the fields of the first lookup table are discarded and consequently at least substantially the (other) half of the fields of the first lookup table are retained. The same then inevitably also applies to the second lookup table. An unequal weighting of the two adapted protective fields is avoided by such an approach.

According to a further advantageous embodiment, regions that are retained during the subsampling and regions that are discarded during the subsampling are homogeneously distributed in the sampling pattern, preferably over the entire two-dimensional extent of the sampling pattern. Said regions can each be groups of neighboring fields. However, such a region can generally also be formed by a single field. The homogeneous distribution of discarded and retained regions ensures a uniform mixing of the first lookup table and the second lookup table during their combination to form the relevant lookup table. In this way, the relevant lookup table can be based substantially everywhere both on parts of the first lookup table and on parts of the second lookup table.

This advantageously results in the relevant lookup table corresponding to a relevant protective field that substantially corresponds to a spatial union of the first adapted protective field and the second adapted protective field. Deviations between the first adapted protective field and the second adapted protective field, which can result from an incorrect determination of one of the two adapted protective fields, can be compensated in this way.

For, if the error causes the faulty adapted protective field to be too small so that a too great an approach of an object to the movable machine (or vice versa) is possible without an engagement into this faulty adapted protective field taking place, in the event of such an approach, an engagement into the other adapted field also takes place in any case. Due to the combination of the two adapted protective fields with a homogeneous distribution, an engagement into the relevant protective field formed by this combination thus also takes place so that the error has no effect and the functional safety remains ensured. However, if the error causes the faulty adapted protective field to be too large, an engagement into the faulty adapted protective field already takes place at an actually still admissible distance and an engagement into the relevant protective field formed by the combination of the two adapted protective fields thus also takes place. This may lead to the safety-related reaction being triggered unnecessarily or unnecessarily early; however, the functional safety is not thereby impaired.

According to a further advantageous embodiment, the sampling pattern is a checkerboard pattern. In such a sampling pattern, a fixed number of fields that are discarded during the subsampling and a corresponding number of fields that are retained during the subsampling in each case regularly alternate in all the rows and columns (in particular, exactly one discarded and one retained field can alternate in each case). As a result, fields whose value corresponds to the value of the respective corresponding field of the first lookup table and fields whose value corresponds to the value of the respective corresponding field of the second lookup table then regularly alternate in the relevant lookup table in a corresponding manner. The first lookup table and the second lookup table are thereby interwoven like a checkerboard in the relevant lookup table.

A checkerboard pattern as a sampling pattern is comparatively easy to realize. Furthermore, regions that are retained during the subsampling and regions that are discarded during the subsampling are homogeneously distributed in a sampling pattern that is a checkerboard pattern; moreover, due to the subsampling in accordance with the checkerboard pattern or the inverse of the checkerboard pattern, precisely half of the fields of the respective lookup table are discarded in each case. The advantages mentioned for the previous embodiments are therefore combined with one another by using a checkerboard pattern as a sampling pattern.

According to a further advantageous embodiment, the method further comprises: that a continuity criterion is checked for the relevant protective field; and that, if the continuity criterion is not met, a warning message is output to a user of the movable machine. In other words, the relevant protective field is checked as to whether it is continuous. The checking of the continuity criterion can in particular take place by the evaluation apparatus.

The checking can, for example, comprise determining whether the relevant protective field forms a single continuous spatial region or has interruptions. Since the relevant protective field can be present in the form of said relevant lookup table, the continuity criterion for the relevant protective field can also be checked based on the relevant lookup table. This can in particular comprise determining differences (in at least one dimension, preferably in both dimensions, of the two-dimensional lookup table) between the values of neighboring fields of the relevant lookup table. For example, for each field of the relevant lookup table, the average difference of the value of this field from the values of the directly neighboring fields can be determined. The continuity criterion can, for example, be met if the difference determined for all the fields is below a certain threshold value. Alternatively thereto, the continuity criterion can, for example, be met if there is at least no group consisting of a certain number of neighboring fields for which the determined difference for all the fields of the group exceeds a certain threshold value.

If the continuity criterion is not met—i.e. if the relevant protective field or the relevant lookup table has one or more discontinuous regions—this is an indication that the first adapted protective field and the second adapted protective field (or the first lookup table and the second lookup table) are not consistent with one another. Since the relevant protective field (or the relevant lookup table) is determined on the basis of both the first adapted protective field and the second adapted protective field, the inconsistency that can be determined based on the continuity criterion advantageously does not need to lead to a safety-related shutdown of the movable machine; rather, the operation of the movable machine can be continued in a safe manner for the time being. However, it is expedient that a detected inconsistency between the adapted protective fields is signaled to a user of the movable machine so that at a suitable point in time—for instance after completion of a certain work process—the error source can be identified and the error that led to the inconsistency can be rectified. A corresponding warning message can be output, for example, in the form of a visual and/or acoustic warning signal.

The safety device according to the invention serves for the safe operation of a movable machine and comprises a sensor apparatus, an evaluation apparatus as well as a first adaptation apparatus and a second adaptation apparatus. The sensor apparatus is in this respect configured to determine a 3D representation of an environment of the movable machine. The first adaptation apparatus is configured to receive state data about the movable machine and, starting from a predefined initial protective field, to determine a first adapted protective field in dependence on the state data. The second adaptation apparatus is configured to receive state data about the movable machine and, starting from the predefined initial protective field, to determine a second adapted protective field in dependence on the state data. The first adaptation apparatus and the second adaptation apparatus preferably each receive the same state data. In this respect, the state data can in particular be received by a control unit for controlling the movable machine. The evaluation apparatus is configured to evaluate the determined 3D representation with respect to whether an object engages into a relevant protective field determined on the basis of both the first adapted protective field and the second adapted protective field, and to output a result signal in dependence on the result of the evaluation. The evaluation apparatus can receive the determined 3D representation from the sensor apparatus in which the evaluation apparatus can also be integrated, however. The relevant protective field can be determined by the evaluation apparatus that can for this purpose receive the first adapted protective field and the second adapted protective field from the adaptation apparatuses that are preferably formed separately from the sensor apparatus and the evaluation apparatus.

The properties, design options and advantages of the elements involved in the method that are described in connection with the method according to the invention also apply correspondingly to the elements of the present safety device according to the invention.

The machine assembly according to the invention comprises a movable machine, a control unit for controlling the movable machine and a safety device according to the invention. The control unit is in this respect configured to receive the result signal from the evaluation apparatus and to trigger a safety-related reaction if the result signal corresponds to an engagement of an object into the relevant protective field. To receive the result signal from the evaluation apparatus, the control unit can be connected directly or indirectly to the evaluation apparatus. The triggering of the safety-related reaction can in particular consist of the control unit controlling the movable machine to move at a reduced speed or to stop.

The machine assembly according to the invention is preferably configured to perform a method according to the invention, in particular in accordance with any one of the described embodiments of the method. As a result, the advantages resulting from the respective embodiment of the method also apply accordingly to the machine assembly.

The invention will be further explained only by way of example in the following with reference to the Figures.

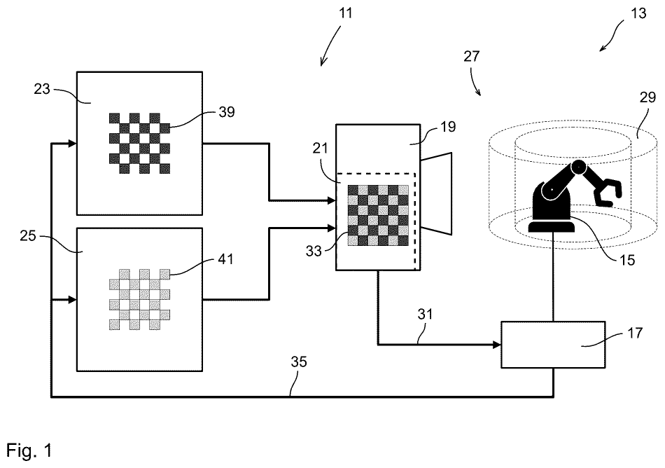

FIG. 1 shows a safety device according to the invention as part of a machine assembly according to the invention in a greatly simplified schematic representation;

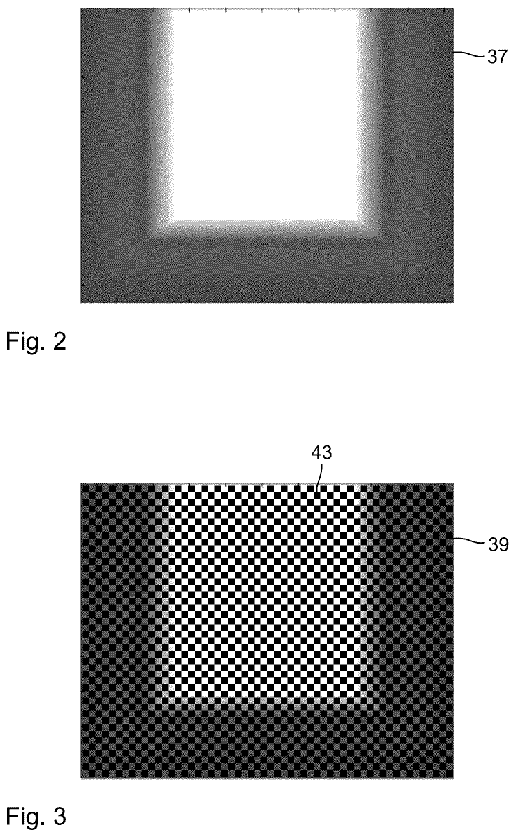

FIG. 2 shows, by way of example, an embodiment of an adapted protective field in the form of a lookup table; and

FIG. 3 shows a partial lookup table formed by subsampling the lookup table shown in FIG. 2.

In FIG. 1, an exemplary embodiment of a safety device 11 according to the invention as part of a machine assembly 13 according to the invention is shown in a highly simplified schematic representation. In addition to the safety device 11, the machine assembly 13 comprises a movable machine 15, which is a robot arm here, and a control unit 17 that is configured to control the movable machine 15.

By means of the control unit 17, the movable machine 15 can in particular be controlled to assume different positions and/or to perform different movements. Furthermore, the control unit 17 can activate or deactivate various operating modes of the movable machine 15, for example an operating mode in which the movable machine 15, by means of a tool provided thereat, processes a workpiece (not shown).

The safety device 11 comprises a sensor apparatus 19, an evaluation apparatus 21 as well as a first adaptation apparatus 23 and a second adaptation apparatus 25. The sensor apparatus 19, which can, for example, be configured as a three-dimensional laser scanner, is configured to acquire position data about an environment 27 of the movable machine 15 and to determine a 3D representation of the environment 27 based on these position data. In the present embodiment, the 3D representation is determined in the form of a depth map, i.e. as a two-dimensional image whose pixels each represent the distance of the spatial point corresponding to the respective pixel from the sensor apparatus 19. The evaluation apparatus 21 is integrated into the sensor apparatus 19 and is configured to evaluate the determined 3D representation with respect to whether an object engages into a relevant protective field 29 that is a defined spatial region within the environment 27 of the movable machine 15.

Depending on the result of this evaluation, the evaluation apparatus 21 outputs a result signal 31 to the control unit 17. If the result signal 31 received by the control unit 17 corresponds to an engagement of an object into the relevant protective field 29, said control unit 17 triggers a safety-related reaction by controlling the movable machine 15 to move at a reduced speed. The safety-related reaction can also consist of the control unit 17 immediately stopping the movable machine 15 completely (emergency stop).

In this way, the movable machine 15 can be operated as part of a human-robot interaction and a danger to the person involved from the movable machine 15 can be avoided in so doing. For the relevant protective field 29 is expediently defined such that it separates a spatial region in which persons can be present from the spatial region which the movable machine 15 can occupy. If an object (for example a person) or the movable machine 15 enters the protective field 29, the safety-related reaction is triggered by which a contact of the object with the movable machine is prevented or it is at least largely ensured that the contact would be harmless. Consequently, the movable machine 15 can be safely operated.

For the evaluation whether an object engages into the relevant protective field 29, the determined 3D representation is compared with the relevant protective field 29. In the embodiment shown, the relevant protective field 29 is for this purpose present in the form of a relevant lookup table 33 that, in terms of its structure (number of rows and columns), corresponds to the 3D representation determined as a depth map. Each value of the determined 3D representation can thereby be compared with the value of the corresponding field of the lookup table 33 for the evaluation of the determined 3D representation.

The relevant protective field 29 can first correspond to an initial protective field that can be defined relative to the movable machine 15. The initial protective field can in this respect also be present as an (initial) lookup table that can be obtained, for example, by converting the initial protective field into a two-dimensional depth map, while considering optical parameters of the sensor apparatus 19. The initial protective field is in this respect fixedly predefined for the respective operation of the movable machine 15 and is static in this regard. However, the relevant protective field 29 is advantageously adapted, in particular continuously, to the respective state of the movable machine 15, for instance to its current position, its current speed and/or its current operating mode, to prevent a larger spatial region than necessary from being inaccessible to persons. For example, the relevant protective field 29 can have a smaller thickness at lower speeds of the movable machine 15 than at higher speeds of the movable machine 15.

So that the relevant protective field 29 can be dynamically adapted to the respective state of the movable machine 15, the first adaptation apparatus 23 and the second adaptation apparatus 25 are provided that each determine an adapted protective field. For this purpose, the two adaptation apparatuses 23, 25 receive, from the control unit 17, state data 35 that comprise information about the current state of the movable machine 15. Starting from the initial protective field, a first adapted protective field 37 is then determined by the first adaptation apparatus 23 and a second adapted protective field is determined by the second adaptation apparatus 25 in dependence on the received state data 35.

So that the safety of the sensor apparatus 19, which is preferably certified for safe operation, is not impaired, the determination of the adapted protective fields preferably takes place outside the sensor apparatus 19 in the adaptation apparatuses 23, 25 that are formed separately from the sensor apparatus 19. The adaptation apparatuses 23, 25 are also formed separately from one another. Furthermore, they are independent of one another in their function. In particular, the first adaptation apparatus 23, for example, uses a different algorithm for the determination of the first adapted protective field than the second adaptation apparatus 25 uses for the determination of the second adapted protective field. Thus, the adaptation of the protective field to the current state of the movable machine 15 takes place not only in a redundant manner, but also in a diverse manner.

In principle, a respective error can occur during the determination of the adapted protective fields. A typical procedure to rule out such an error is to compare the two adapted protective fields with one another. For, due to the low probability that two adapted protective fields determined in different ways are each determined incorrectly and lead to the same incorrectly adapted protective field in so doing, it can be concluded from a match between the two adapted protective fields that there is no error so that the relevant protective field 29 can easily be equated with one of the two (matching) adapted protective fields. However, if a deviation between the two adapted protective fields is detected, it cannot be determined which of the two adapted protective fields is faulty so that a safety-related reaction is required, namely usually a shutdown of the movable machine 15.

To avoid this and the time-consuming comparison of the adapted protective fields, the relevant protective field 29 is determined differently according to the invention. In particular, no comparison of the two adapted protective fields takes place; rather, the relevant protective field 29 is determined directly on the basis of both the first adapted protective field and the second adapted protective field. The relevant protective field 29 in this regard corresponds to a combination of the two adapted protective fields determined by the adaptation apparatuses 23, 25, wherein this combination corresponds to a spatial superposition of the adapted protective fields in the embodiment example shown.

The first adapted protective field and the second adapted protective field are each determined in the form of a lookup table, namely in the form of a first lookup table 37 or in the form of a second lookup table, like the relevant protective field 29. FIG. 2 shows an example of a first lookup table 37 as an image, wherein the brightness of the pixels of the image in each case corresponds to the value of the corresponding field of the first lookup table 37. The first lookup table 37 and the second lookup table are each configured in the form of a depth map and have the same dimensions as the 3D representation that is determined by the sensor apparatus and is also present as a depth map.

However, the adaptation apparatuses 23, 25 do not completely output the determined first lookup table 37 and the determined second lookup table to the evaluation apparatus 21, but only a part of each, namely a first partial lookup table 39 and a second partial lookup table 41. The first partial lookup table 39 is formed by subsampling the first lookup table 37 in accordance with a predefined sampling pattern 43, which is a checkerboard pattern, while the second partial lookup table 41 is formed by subsampling the second lookup table in accordance with the inverse of the sampling pattern 43. In the second partial lookup table 41, in particular those fields which are discarded in the first partial lookup table 39 are therefore retained during the subsampling, and vice versa. The two partial lookup tables 39 and 41 are complementary to one another in this regard. The relevant lookup table 33 can therefore be easily formed in that it contains all the values of the first partial lookup table 39 (i.e. all the retained values of the first lookup table 37) and all the values of the second partial lookup table 41 (i.e. all the retained values of the second lookup table) at their respective positions.

In FIG. 3, an example of a first partial lookup table 39 is shown that is based on the first lookup table 37 shown in FIG. 2 and that is formed by subsampling the first lookup table 37 in accordance with the sampling pattern 43 that is checkerboard pattern. In this respect, all the discarded fields of the first lookup table 37 are shown in black in the partial lookup table 39. The first partial lookup table 39 is also shown in FIG. 1, but there—just like the second partial lookup table 41 and the relevant lookup table 33 which are also shown in FIG. 1—in a greatly simplified representation: Only a few rows and columns are shown in each case, wherein the discarded fields are not shown in black here, but are shown empty (white); furthermore, the brightness of the fields of the lookup tables shown in FIG. 1 does not correspond to the value of the respective field of the respective lookup table, but in FIG. 1 merely serves to differentiate between fields of the first partial lookup table 39 and fields of the second partial lookup table 41, in particular to indicate which fields of the relevant lookup table 33 originate from the first partial lookup table 39 and which from the second partial lookup table 41.

The representation illustrates that, in the relevant lookup table 33, the first lookup table 37 and the second lookup table are so-to-say interwoven. The first lookup table 37 and the second lookup table each contribute half of the relevant lookup table 33 in this respect, wherein the parts taken from the first partial lookup table 39 and the parts taken from the second partial lookup table 41 are distributed homogeneously over the entire relevant lookup table 33.

In this way, when evaluating the determined 3D representation based on the relevant lookup table 33, the first lookup table 37 and the second lookup table are considered equally, as if the evaluation were performed simultaneously with respect to the first adapted protective field, on the one hand, and with respect to the second adapted protective field, on the other hand. As a result, a high safety is thereby achieved without having to compare the adapted protective fields with one another and without a possible discrepancy between the two adapted protective fields immediately having to lead to a safety-related shutdown of the movable machine 15. Thus, based on dynamically adapted protective fields, the movable machine 15 can be particularly productively operated with a high safety level.

### REFERENCE NUMERALS

11 safety device
13 machine assembly
15 movable machine
17 control unit
19 sensor apparatus
21 evaluation apparatus
23 first adaptation apparatus
25 second adaptation apparatus
27 environment
29 relevant protective field
31 result signal
33 relevant lookup table
35 state data
37 first lookup table
39 first partial lookup table
41 second partial lookup table
43 sampling pattern

1. A method for the safe operation of a movable machine,
the method comprising the following:
that the movable machine is controlled by a control unit;
that a sensor apparatus determines a 3D representation of an environment of the movable machine;
that an initial protective field is predefined that is a defined spatial region within the environment of the movable machine;
that a first adaptation apparatus and a second adaptation apparatus receive state data about the movable machine from the control unit, wherein the first adaptation apparatus, starting from the initial protective field, determines a first adapted protective field in dependence on the state data and the second adaptation apparatus, starting from the initial protective field, determines a second adapted protective field in dependence on the state data;
that a relevant protective field is determined on the basis of both the first adapted protective field and the second adapted protective field;
that an evaluation apparatus evaluates the determined 3D representation with respect to whether an object engages into the relevant protective field, and outputs a result signal in dependence on the result of the evaluation; and
that the control unit triggers a safety-related reaction if the result signal corresponds to an engagement of an object into the relevant protective field.

2. The method according to claim 1,
wherein the first adapted protective field is determined in accordance with a first algorithm and the second adapted protective field is determined in accordance with a second algorithm that is different from the first algorithm.

3. The method according to claim 1,
wherein the determination of the relevant protective field comprises that the first adapted protective field and the second adapted protective field are spatially superposed.

4. The method according to claim 1,
wherein the relevant protective field is determined in the form of a relevant lookup table, and
wherein said evaluation comprises that the determined 3D representation is compared with the relevant lookup table.

5. The method according to claim 4,
wherein the first adapted protective field is determined in the form of a first lookup table,
wherein the second adapted protective field is determined in the form of a second lookup table, and
wherein the determination of the relevant protective field comprises:
that a first partial lookup table is formed by subsampling the first lookup table in accordance with a predefined sampling pattern;
that a second partial lookup table is formed by subsampling the second lookup table in accordance with the inverse of the predefined sampling pattern; and
that the relevant lookup table is formed by combining the first partial lookup table with the second partial lookup table.

6. The method according to claim 5,
wherein, due to the subsampling, in each case at least substantially half of the fields of the respective lookup table are discarded.

7. The method according to claim 5,
wherein regions that are retained during the subsampling and regions that are discarded during the subsampling are homogeneously distributed in the sampling pattern.

8. The method according to claim 5,
wherein regions that are retained during the subsampling and regions that are discarded during the subsampling regularly alternate in the sampling pattern.

9. The method according to claim 5,
wherein the sampling pattern is a checkerboard pattern.

10. The method according to claim 1,
wherein the method further comprises
that a continuity criterion is checked for the relevant protective field; and
that, if the continuity criterion is not met, a warning message is output to a user of the movable machine.

11. A safety device for the safe operation of a movable machine,
wherein the safety device comprises a sensor apparatus, an evaluation apparatus as well as a first adaptation apparatus and a second adaptation apparatus,
wherein the sensor apparatus is configured to determine a 3D representation of an environment of the movable machine,
wherein the first adaptation apparatus is configured to receive state data about the movable machine and, starting from a predefined initial protective field, to determine a first adapted protective field in dependence on the state data,
wherein the second adaptation apparatus is configured to receive state data about the movable machine and to determine a second adapted protective field starting from the predefined initial protective field in dependence on the state data, and
wherein the evaluation apparatus is configured to evaluate the determined 3D representation with respect to whether an object engages into a relevant protective field determined on the basis of both the first adapted protective field and the second adapted protective field, and to output a result signal in dependence on the result of the evaluation.

12. The safety device according to claim 11,
wherein the evaluation apparatus is integrated into the sensor apparatus.

13. The safety device according to claim 11,
wherein the first adaptation apparatus and the second adaptation apparatus are formed separately from the sensor apparatus and the evaluation apparatus.

14. A machine assembly that comprises a movable machine, a control unit for controlling the movable machine and a safety device according to claim 11, wherein the control unit is configured to receive the result signal from the evaluation apparatus and to trigger a safety-related reaction if the result signal corresponds to an engagement of an object into the relevant protective field.

15. The machine assembly according to claim 14 that is configured to perform a method according for the safe operation of a movable machine.

16. The machine assembly according to claim 15, the method comprising the following:
that the movable machine is controlled by a control unit;
that a sensor apparatus determines a 3D representation of an environment of the movable machine;
that an initial protective field is predefined that is a defined spatial region within the environment of the movable machine;
that a first adaptation apparatus and a second adaptation apparatus receive state data about the movable machine from the control unit, wherein the first adaptation apparatus, starting from the initial protective field, determines a first adapted protective field in dependence on the state data and the second adaptation apparatus, starting from the initial protective field, determines a second adapted protective field in dependence on the state data;
that a relevant protective field is determined on the basis of both the first adapted protective field and the second adapted protective field;
that an evaluation apparatus evaluates the determined 3D representation with respect to whether an object engages into the relevant protective field, and outputs a result signal in dependence on the result of the evaluation; and
that the control unit triggers a safety-related reaction if the result signal corresponds to an engagement of an object into the relevant protective field.
